(19) United States
(12) Patent Application Publication
(10) Pub. No.: US 2017/0104710 A1
(43) Pub. Date: Apr. 13, 2017

(54) METHOD AND DEVICE FOR SENDING MICROBLOG ON TELEVISION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Min WANG, Tianjin (CN); Feng PAN, Tianjin (CN); Jia YU, Tianjin (CN)

(21) Appl. No.: 15/244,787

(22) Filed: Aug. 23, 2016

Related U.S. Application Data
(63) Continuation of application No. PCT/CN2016/088883, filed on Jul. 6, 2016.

(30) Foreign Application Priority Data
Oct. 13, 2015 (CN) 201510656970.1

(51) Int. Cl. H04L 12/58; H04N 21/4788; H04N 21/475; H04L 29/08

(52) U.S. Cl. CPC H04L 51/32; H04L 67/10; H04N 21/4788; H04N 21/475; H04L 67/306

(57) ABSTRACT

The embodiments of the present disclosure disclose a method for sending a microblog onto a television and the television and relate to the technical field of information processing to solve the problem that in the prior art, the microblog cannot be sent on the television. According to the technical scheme, the method comprises the steps of: acquiring a microblog sending starting command input by a user; acquiring a program name corresponding to a current program being played if a microblog account number logs in; processing the program name according to a preset format of a microblog head to generate a microblog head; acquiring a microblog comment content input by the user according to the microblog head; and sending the microblog head and the microblog comment content to a microblog server by using the microblog account number.

### CROSS-REFERENCE TO RELATED APPLICATIONS

This application is a continuation of International Application No. PCT/CN2016/088883 filed on Jul. 6, 2016, which is based upon and claims priority to Chinese Patent Application No. 201510656970.1, entitled “Method for sending microblog on television and television”, filed to State Intellectual Property Office of The P.R.C on Oct. 13, 2015, the entire contents of all of which are incorporated herein by reference.

### TECHNICAL FIELD

The disclosure relates to the technical field of information processing, and particularly relates to a method for sending a microblog on a television and the television.

### BACKGROUND

With the development of the Internet era, the demand of people on social media activity is bigger and bigger, and at present, the microblog has become an indispensable social activity tool of people in spare time. A user may log in to a microblog client from terminal equipment such as a mobile phone, a tablet personal computer and a PC computer to realize social activity interaction with other people by virtue of operations such as adding topic discussion and issuing personal status.

At present, if the user wants to issue microblog comments on a hot topic, the user firstly needs to manually input the name of the topic according to a fixed format, and then inputs the comment content. After the commitment content is fully input, the comment and the topic in the fixed format are together sent to a microblog server, and the microblog server will add the microblog comment content input by the user into a hot topic comment list corresponding to the name of the topic according to the name of the topic, so that a purpose of issuing the microblog comment on the hot topic is achieved. However, the method for sending the microblog in the prior art cannot be applied to terminal equipment such as a television.

### SUMMARY

The embodiments of the present disclosure aim to provide the method for sending the microblog onto televisions for solving the problem that the microblog cannot be sent onto televisions in the prior art.

Correspondingly, the embodiments of the present disclosure further provide a television for ensuring implementation and application of the method.

According to one aspect of the present disclosure, an embodiment of the present disclosure discloses the method for sending the microblog onto televisions. The method includes the steps of: acquiring a microblog sending starting command input by a user; acquiring a program name corresponding to a current program being played if a microblog account number logs in; processing the program name according to a preset format of a microblog head to generate a microblog head; acquiring a microblog comment content input by the user according to the microblog head; and sending the microblog head and the microblog comment content to a microblog server by using the microblog account number.

According to another aspect of the present disclosure, an embodiment of the present disclosure discloses an electronic device, which may be pre-installed with a microblog client. The electronic device includes at least one processor; and a memory communicably connected with the at least one processor for storing instructions executable by the at least one processor, wherein execution of the instructions by the at least one processor causes the at least one processor to: acquire the microblog sending starting command input by a user; acquire the program name corresponding to a current program being played if a microblog account number logs in; process the program name acquired by the second acquiring module, according to a preset microblog head, to generate a microblog head; acquire a microblog comment content input by the user according to the microblog head; send the microblog head and the microblog comment content to a microblog server by using the microblog account number.

According to another aspect of the present disclosure, an embodiment of the present disclosure provides a computer program, which includes a computer readable code. When the computer readable code operates in the television, the television executes the method for sending the microblog on the television.

According to another aspect of the present disclosure, an embodiment of the present disclosure provides a non-transitory computer readable medium storing executable instructions that, when executed by an electronic device, cause the electronic device to: acquiring a microblog sending starting command input by a user; acquiring a program name corresponding to a current program being played if a microblog account number logs in; processing the program name according to preset microblog head format to generate a microblog head; acquiring the microblog comment content input by the user according to the microblog head; and sending the microblog head and the microblog comment content to the microblog server by using the microblog account number.

According to the method for sending the microblog onto televisions and the television provided by the embodiments of the present disclosure, after the microblog sending starting command input by the user is received, the program name corresponding to the current program being played may be acquired; the program name is processed by using the preset microblog format to generate the microblog head; the microblog comment content input according to the microblog head is received, and the microblog head and the microblog comment content are together sent to the microblog server, so that the purpose of sending the microblog comment corresponding the current program being played on television is achieved. The problem that the microblog cannot be sent onto televisions in the prior art is solved. The user needs not to know the program name in advance, and may automatically acquire the program name according to a technical scheme provided by the embodiments of the present disclosure, so that the problem that the corresponding microblog commitment cannot be sent when the user does not know the program name is further solved. Further, according to the technical scheme provided by the embodiments of the present disclosure, the program name may be automatically acquired, and the user needs not to input the program name manually, so that the user's operation is simpler and more convenient.

The above description is only the summary of the technical scheme of the present disclosure. In order to understand the technical means of the present disclosure more clearly to implement the technical means according to the content of the description, and to make the above and other purposes, characteristics and advantages of the present disclosure more obvious and understandable, detailed description of the present disclosure are listed below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of the method for sending the microblog on the television provided by embodiments of the present disclosure.

FIG. 2 is a structural schematic diagram I of the television provided by embodiment of the present disclosure.

FIG. 3 is a structural schematic diagram II of the television provided by embodiment of the present disclosure.

FIG. 4 is a structural schematic diagram III of the television provided by embodiment of the present disclosure.

FIG. 5 is a structural schematic diagram IV of the television provided by embodiment of the present disclosure.

FIG. 6 is a structural schematic diagram V of the television provided by embodiment of the present disclosure.

FIG. 7 is a structural schematic diagram VI of the television provided by embodiment of the present disclosure.

FIG. 8 schematically depicts a block diagram of an electronic device for executing the method according to an embodiment of the present disclosure.

FIG. 9 schematically depicts a storage unit for keeping or carrying a program code, which realizes the method according to an embodiment of the present disclosure.

### DETAILED DESCRIPTION

In order to make the purpose, the characteristics and advantages of the present disclosure more obvious and understandable, the present disclosure is further described in detail by combining the drawings with the description of the embodiments.

In order to solve the problem that in the prior art, the microblog cannot be sent onto televisions, the embodiments of the present disclosure provide a method for sending a microblog onto a television and the television.

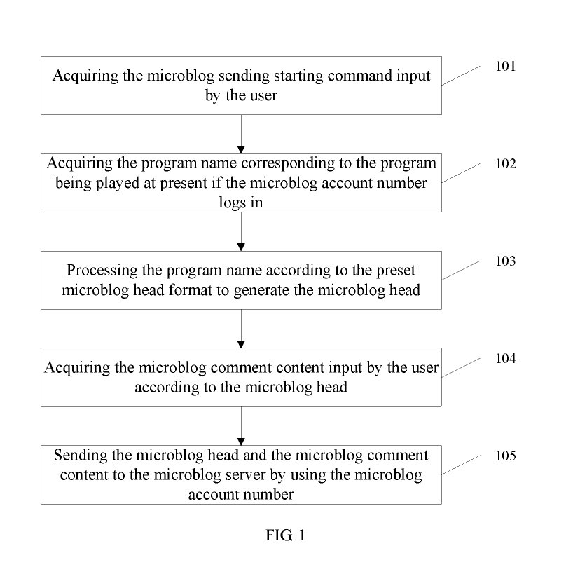

Shown in the FIG. 1, the method for sending the microblog on the television provided by the embodiment of the present disclosure includes:

Step 101, acquiring a microblog sending starting command input by a user.

In the embodiment, the step 101 may acquire the microblog sending starting command input by the user by various ways, for example, setting a microblog sending entry on a microblog client interface of the television in advance. The step 101 may acquires the microblog sending starting command by way of clicking the microblog sending entry by the user. For another example, setting a share button on a remote controller of the television in advance, the step 101 acquires the microblog sending starting command by way of clicking the share button by the user.

Of course, the above two conditions are only specific examples for description. In an actual using process, the step 101 further may acquire the microblog sending starting command input by the user by other ways, and every condition is not described therein.

Step 102, acquiring a program name corresponding to a current program being played if a microblog account number logs in.

In the embodiment, the microblog client of the television may register a WeiboReceiver broadcast receiver after the television is started. When the user using a signal source or a carousel channel watches the program being played, the signal source or the carousel channel will send the program name corresponding to the program being played to the television system in form of broadcast. The step 102 may receive the program name corresponding to the program being played from the television system through the WeiboReceiver and stores the program name in a variable mProgramName for storing the current program name.

Further, if no microblog account number logs in, the method for sending the microblog on the television provided by the embodiment of the present disclosures further may include a step of logging in the microblog account number.

Specifically, the method for sending the microblog on the television provided by the embodiments of the present disclosure may include the steps of: presetting a login page on the microblog client of the television; when no microblog account numbers logging in are detected, manually inputting the microblog login information through the login page by the user, wherein the microblog login information includes user name and password and the like; and logging in the microblog account number by receiving the microblog login information manfully input by the user.

For the convenience of logging in the microblog account number by the user, the operating step of logging in the microblog account number by the user is simplified. The technical scheme provided by the embodiment of the present disclosures may obtain the microblog login information of a mobile terminal in a same local area network and logging in the microblog account number according to the microblog login information.

The above is only specific examples. In the actual using process, the microblog account number may be logged in by any one mode known by the technical staff in the field. The modes are not described in detail herein.

According to the embodiment of the present disclosure, the microblog login information of the microblog account number is stored in an active user list mActivityUser, and the microblog login information corresponding to all login microblog account numbers in a login user list mLoginUserList.

Step 103, processing the program name according to the preset microblog head format to generate a microblog head.

Specifically, in the embodiment, the preset microblog head format may be #program name#. In the step 103, the program name may be treated according to the preset microblog head format to generate the microblog head. The embodiment of the present disclosure does not specifically limit the microblog head format. In the actual using process, the user may customize the microblog head format. The embodiment of the present disclosure does not give description in detail.

Step 104, acquiring the microblog comment content input by the user according to the microblog head.

In the embodiment, after the microblog head is generated in the step 103, the microblog head may be displayed by sending the microblog page by the microblog client onto the television and the user is indicated to continuously input the microblog comment content behind the displayed microblog head. At the moment, in the step 104, the microblog comment content input by the user according to the microblog head may be acquired.

Step 105, sending the microblog head and the microblog comment content to the microblog server by using the microblog account number.

In the embodiment, a microblog sending button may be set in the microblog sending page of the microblog client of the television in advance. When a command of the user pressing the microblog sending button is received, in the step 105, the microblog head and the microblog comment content are sent to the microblog server by using the microblog account number.

Specifically, in the step 105, a sendWeibo microblog sending method in CommentsManager microblog comment management may be invoked by the microblog client. The microblog head and the microblog comment content are sent to the microblog server by using the microblog account number.

Further, in order to ensure that the microblog sent by the user is normally transmitted, when the microblog server receives the microblog head and the microblog comment content sent in the step 105, a send succeeded message is returned, and the microblog client displays the send succeeded message to the user; when the microblog server fails to receive the microblog head and the microblog comment content sent in the step 105, a send failed message is returned, and the microblog client displays the send failed message to the user, so that the user may have a choice of re-sending the microblog head and the microblog comment content or giving up to send the microblog head and the microblog comment content.

Further, in order that the microblog comment sent by the user is more abundant and intuitive, the method for sending the microblog on the television provided by the embodiment of the present disclosure further may include screen capturing treatment on the program being played to obtain a screen capturing picture before the step 105. At the moment, the step 105 may be replaced to send the microblog head, the microblog comment content and the screen capturing picture to the microblog server by adopting the microblog account number.

Specifically, the technical scheme provided by the embodiment of the present disclosure may invoke a CaptureScreen screen capturing startCapture screen capturing method and require the television system to capture screen of a video stream of the program being played. After screen capturing, the television system sends picture data mBitmap to the microblog client. The microblog client receiving the bBitmap sent by the television system displays the current screen capturing picture. Meanwhile, the current program name stored by mProgramName is added with a prefix #super television# to be display in a defaulted microblog character region.

It should be noted that the embodiment of the present disclosure does not limit the specific position of the step of performing screen capturing processing on the current program being played to obtain the screen capturing picture. In the actual using process, the step may be set after the step 102 but before the step 103 or after the step 103 but before the step 104. Of course, the step may be set in other positions. Detailed description on the positions one by one is not listed herein.

Further, in order that the user may flexibly adopt different microblog account numbers to publish the microblog comment, the method for sending the microblog on the television provided by the embodiment of the present disclosure further may include a step of acquiring a changed microblog account number if the microblog account number needs to be changed before the step 105. At the moment, the step 105 may be replaced to send the microblog head and the microblog comment content to the microblog server by adopting the changed microblog account number.

Specifically, according to the technical scheme provided by the embodiment of the present disclosure, when the microblog account number is changed, the user name and password that are manually input by the user may be received to change the microblog account number, and the microblog login information corresponding to any one login microblog account number is selected from the mLoginUserList list to change the microblog account number and the microblog login information corresponding to the changed microblog account number is stored to the mActivityUser for replacing the unchanged microblog login information.

Further, in order that the user may conveniently and quickly acquire the microblog comments corresponding to the current program being played through the microblog client of the mobile terminal such as the mobile phone, the method for sending the microblog on the television provided by the embodiment of the present disclosure further may include a step of sending the program name to the microblog server so as to send the microblog comments corresponding to the program name to the microblog client of the mobile terminal by the microblog server when the user needs to examine the microblog comments corresponding to the current program being played through the mobile terminal.

Specifically, a my television circle entry is set on the microblog client of the mobile terminal such as the mobile phone may be set in advance. When the user clicks the button of my television circle, the microblog client of the mobile terminal such as the mobile phone will send a microblog comment request corresponding to the current program being played to the microblog server through the logged microblog account number. At the moment, according to the technical scheme provided by the embodiment of the present disclosure, the program name is sent to the microblog server, and the microblog receiving the program name sends the microblog comments corresponding to the program name to the mobile terminal such as the mobile phone.

Further, in order to save the microblog account number resources and avoid the loss to the user caused by missing of the microblog account number, the method for sending the microblog on the television provided by the embodiment of the present disclosure further includes a step of logging off the microblog account number.

Specifically, according to the technical scheme provided by the embodiment of the present disclosure, a log off button may be set in a microblog client display interface of the television. When an operating command of the user clicking the log off button is received, the microblog account number is logged off. Further, in order to simplify the operating step of logging off the microblog account number, the step of logging off the microblog account number provided by the embodiment of the present disclosure may specifically include: periodically detecting the login state of the microblog account number in the mobile terminal in the local area network to acquire a detection result; if the detection result indicates that the microblog account number is in an offline state in the mobile terminal within a preset time interval, logging off the microblog account number.

It should noted that with respect to the embodiment of the method, for brief description, the embodiment is expressed as a series of movement combination. But the technical staff in the field shall know that the embodiment of the present disclosure is not limited by the described sequence of movements because some steps may be in other sequences or may be proceeded at the same time according to the embodiment of the present disclosure. Then, the technical staff in the field shall also know that the embodiments described in the description are preferred embodiments, and referred movements are not necessary to the embodiments of the present disclosure.

The method for sending the microblog onto televisions provided by the embodiments of the present disclosure includes the steps of: acquiring the program name corresponding to the current program being played after receiving the microblog sending starting command input by the user; processing the program name by using the preset microblog format to generate the microblog head; receiving the microblog comment content input by the user according to the microblog head; and sending the microblog head and the microblog comment content together to the microblog server so as to achieve the purpose of sending the microblog comments corresponding to the current program being played on the television. The problem that the microblog cannot be sent onto televisions in the prior art is solved. The user needs not to know the program name in advance, and may automatically acquire the program name according to a technical scheme provided by the embodiments of the present disclosure, so that the problem that the corresponding microblog comment cannot be sent when the user does not know the program name is further solved. Further, according to the technical scheme provided by the embodiments of the present disclosure, the program name may be automatically acquired, and the user needs not to input the program name manually, so that the user's operation is simpler and more convenient.

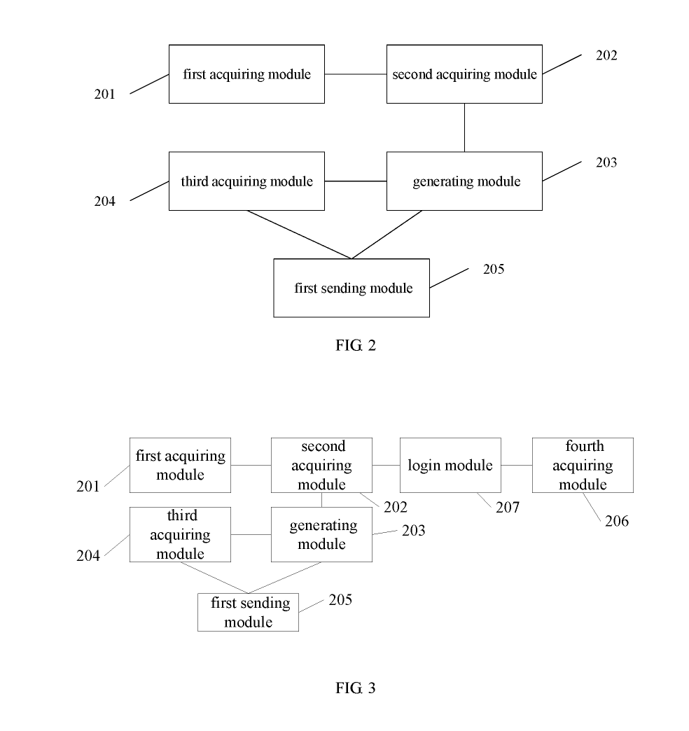

Shown in the FIG. 2, the embodiments of the present disclosure further provide a television that is pre-installed with a microblog client. The television includes:

a first acquiring module 201 for acquiring a microblog sending starting command input by a user;

a second acquiring module 202 for acquiring the program name corresponding to a current program being played if a microblog account number logs in;

a generating module 203 for processing the program name acquired by the second acquiring module 202, according to a preset microblog head, to generate a microblog head;

a third acquiring module 204 for acquiring a microblog comment content input by the user according to the microblog head generated by the generating module 203; and

a first sending module 205 for sending the microblog head generated by the generating module 203 and the microblog comment content acquired by the third acquiring module 204 to a microblog server by using the microblog account number.

Further, shown in the FIG. 3, the television provided by the embodiments of the present disclosure may further include:

a fourth acquiring module 206 for acquiring the microblog login information of the mobile terminal in a same local area network if no microblog accounting numbers log in; and

a login module 207 for logging the microblog account number according to the microblog login information acquired by the fourth acquiring module 206.

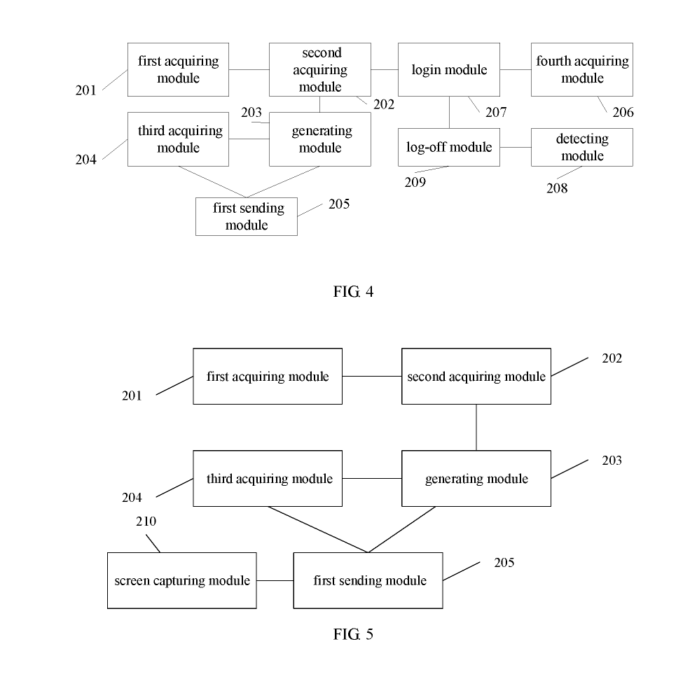

Further, shown in the FIG. 4, the television provided by the embodiments of the present disclosure further may include:

a detection module 208 for periodically detecting the login state of the microblog account number in the mobile terminal in the local area network to acquire a detection result; and

a log-off module 209 for logging off the microblog account number if the detection result acquired by the detection module 208 indicates that the microblog account number is in an offline state in the mobile terminal within a preset time interval.

Further, shown in the FIG. 5, the television provided by the embodiments of the present disclosure further may include:

a screen capturing module 210 for performing screen capturing processing on the current program being played to obtain the screen capturing picture; and

a first sending module 205 for further sending the microblog head generated by the generating module 203, the microblog comment content acquired by the third acquiring module 204 and the screen capturing picture acquired by the screen capturing module 210 to the microblog server by using the microblog account number.

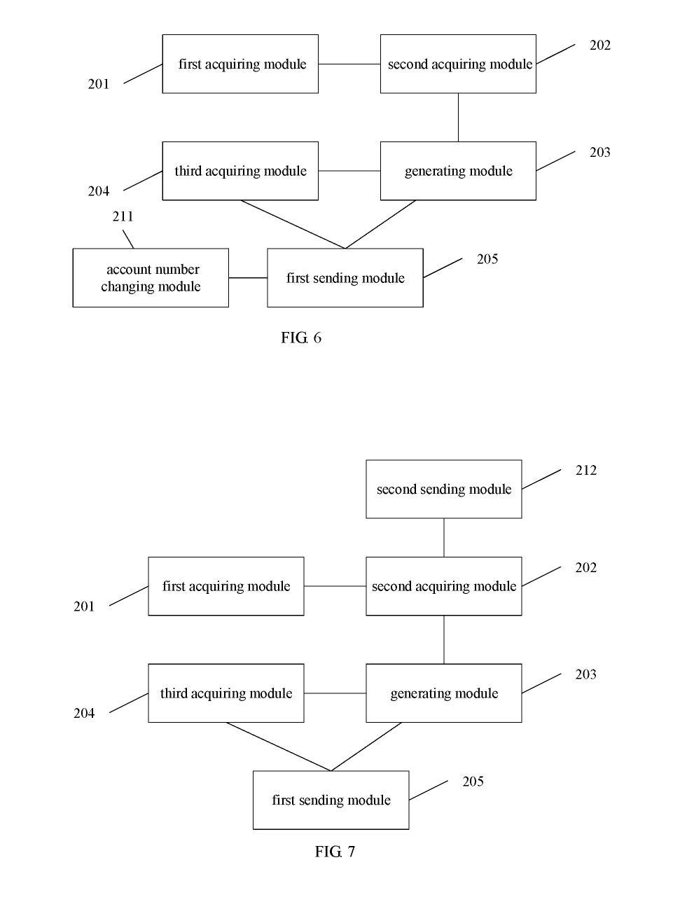

Further, shown in the FIG. 6, the television provided by the embodiments of the present disclosure further may include:

an account number changing module 211 for acquiring a changed microblog account number if the microblog account number needs to be changed; and

a first sending module 205 for further sending the microblog head generated by the generating module 203 and the microblog comment content acquired by the third acquiring module 204 to a microblog server by using the changed microblog account number acquired by the account number changing module 211.

Further, shown in the FIG. 7, the television provided by the embodiments of the present disclosure further may include:

a second sending module 212 for sending the program name to the microblog server so as to send the microblog comments corresponding to the program name to the microblog client of the mobile terminal by the microblog server when the user needs to examine the microblog comments corresponding to the current program being played through the mobile terminal.

Specific implement methods of the television provided by the embodiments of the present disclosure shown in FIG. 2-7 may refer to the method for sending the microblog onto televisions provided by the embodiments of the present disclosure shown in the FIG. 1. The specific implement methods are not described herein in detail.

The television provided by the embodiments of the present disclosure is pre-installed with the microblog client. The television may acquire the program name corresponding to the current program being played after receiving the microblog sending starting command input by the user; process the program name by using the preset microblog format to generate the microblog head; receive the microblog comment content input by the user according to the microblog head; and send the microblog head and the microblog comment content together to the microblog server so as to achieve the purpose of sending the microblog comments corresponding to the current program being played on the television. The problem that the microblog cannot be sent on the television in the prior art is solved. The user needs not to know the program name in advance, and may automatically acquire the program name according to a technical scheme provided by the embodiments of the present disclosure, so that the problem that the corresponding microblog commitment cannot be sent when the user does not know the program name is further solved. Further, according to the technical scheme provided by the embodiments of the present disclosure, the program name may be automatically acquired, and the user needs not to input the program name manually, so that the user's operation is simpler and more convenient.

The embodiments in the description are described in a progressive manner. In each embodiment, difference from other embodiments is mainly explained. The same and similar parts of the embodiments refer to each other.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

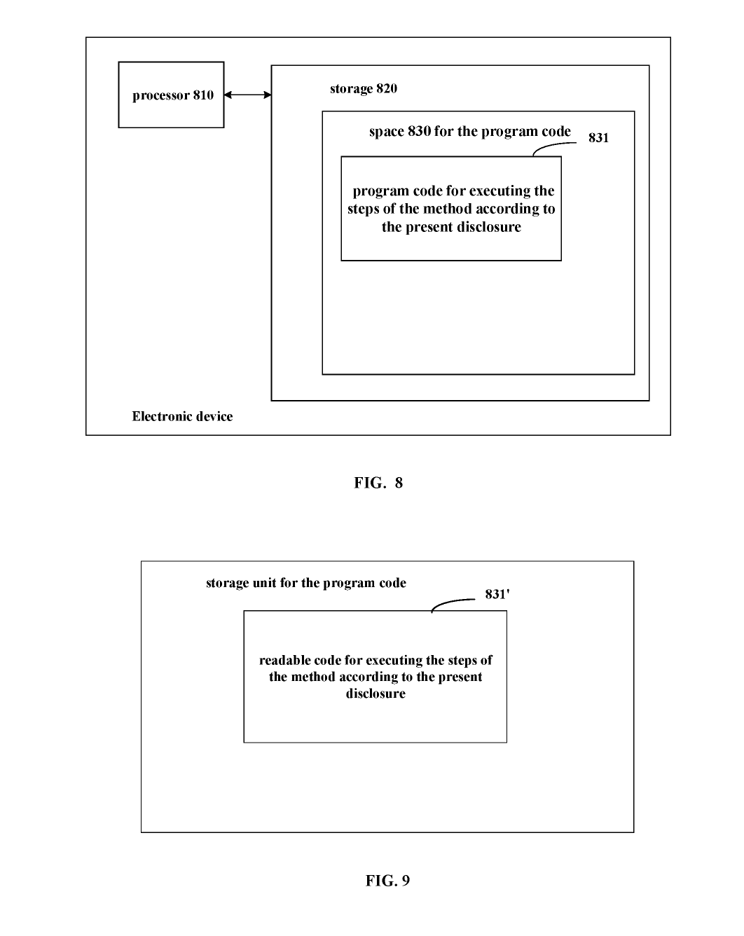

For example, FIG. 8 illustrates a block diagram of an electronic device for executing the method according the disclosure. The electronic device may be the television above. Traditionally, the electronic device includes a processor 810 and a computer program product or a computer readable medium in form of a memory 820. The memory 820 could be electronic memories such as flash memory, EEPROM (Electrically Erasable Programmable Read-Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the electronic device as shown in FIG. 8. The program codes may be compressed for example in an appropriate form. Usually, the memory cell includes computer readable codes 831′ which may be read for example by processors 810. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure may be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described with reference to the method, the terminal equipment (system) and a flow diagram and/or a block diagram of a computer program product of the embodiments of the present disclosure. It should be understandable that each flow and/or block in the flow diagram and/or the block as well as combination of the flow and/or block in the flow diagram and/or the block are realized through computer program commands. The computer program commands may be provided to a universal computer, a dedicated computer, an embedded processor or a processor of other programmable data processing terminal equipment to generate a machine, so that the command executed by the computer or the process of other programmable data processing terminal equipment generates a device for realizing an appointed function in one flow or multiple flows of the flow diagram and/or one block or multiple blocks in the block diagram.

The computer program commands further may be stored in a computer readable storage capable of guiding the computer or the other programmable data processing terminal equipment to work in a special mode, so that the command stored in the computer readable storage generates a manufactured material including a command device. The command device realizes an appointed function in one flow or multiple flows of the flow diagram and/or one block or multiple blocks in the block diagram.

The computer program commands further may be loaded to the computer or other programmable data processing terminal equipment, so that the a series of operating steps are executed on the computer or other programmable data processing terminal equipment to generate processing realized by the computer, so that the command executed on the computer or other programmable data processing terminal equipment provides the step of realizing an appointed function in one flow or multiple flows of the flow diagram and/or one block or multiple blocks in the block diagram.

The above is detailed introduction to the method for sending the microblog on the television and the television provided by the present disclosure. In the present disclosure, the principle and embodiments are illustrated by applying specific individual examples. The description of the embodiments is only used for helping to understand the method and the core thought of the present disclosure. Meanwhile, for the ordinary technical staff in the field, both the specific embodiments and the application range will be changed according to the thought of the present disclosure. In conclusion, the content of the description should not be interpreted as limitation on the present disclosure.

What is claimed is:

1. A method for sending a microblog onto a television, comprising:
acquiring a microblog sending starting command input by a user;
acquiring a program name corresponding to a current program being played if a microblog account number logs in;
processing the program name according to preset microblog head format to generate a microblog head;
acquiring the microblog comment content input by the user according to the microblog head;
and sending the microblog head and the microblog comment content to the microblog server by using the microblog account number.

2. The method according to claim 1, further comprising:
acquiring the microblog login information of a mobile terminal in a same local area network if no microblog accounting numbers log in;
and logging the microblog account number according to the microblog login information.

3. The method according to claim 2, further comprising:
periodically detecting the login state of the microblog account number in the mobile terminal in the local area network to acquire a detection result;
and if the detection result indicates that the microblog account number is in an offline state in a mobile terminal within a preset time interval, logging off the microblog account number.

4. The method according to claim 1, further comprising:
performing screen capturing processing on the current program being played to obtain a screen capturing picture;
and replacing the step of sending the microblog head and the microblog comment content to the microblog server by using the microblog account number to:
the step of sending the microblog head, the microblog comment content and the screen capturing picture to the microblog server by using the microblog account number.

5. The method according to claim 1, further comprising:
acquiring the changed microblog account number if the microblog account number needs to be changed;
and replacing the step of sending the microblog head and the microblog comment content to the microblog server by using the microblog account number to:
the step of sending the microblog head and the microblog comment content to the microblog server by using the changed microblog account number.

6. The method according to claim 1, further comprising:
sending the program name to a microblog server so as to send microblog comments corresponding to the program name to a microblog client of the mobile terminal by the microblog server when the user needs to examine the microblog comments corresponding to the current program being played through the mobile terminal.

7. An electronic device pre-installed with the microblog client, comprising:
at least one processor; and
a memory communicably connected with the at least one processor for storing instructions executable by the at least one processor, wherein execution of the instructions by the at least one processor causes the at least one processor to:
acquire a microblog sending starting command input by a user;
acquire the program name corresponding to a current program being played if a microblog account number logs in;
process the program name acquired by the second acquiring module, according to a preset microblog head, to generate a microblog head;
acquire the microblog commitment content input by the user according to the microblog head;
send the microblog head and the microblog commitment content to a microblog server by using the microblog account number.

8. The electronic device according to claim 7, wherein execution of the instructions by the at least one processor causes the at least one processor to:
acquire the microblog login information of the mobile terminal in the same local area network if no microblog accounting numbers log in;
log the microblog account number according to the microblog login information.

9. The electronic device according to claim 8, wherein execution of the instructions by the at least one processor causes the at least one processor to:
periodically detect the login state of the microblog account number in the mobile terminal in the local area network to acquire a detection result;
log off the microblog account number if the detection result indicates that the microblog account number is in an offline state in the mobile terminal within a preset time interval.

10. The electronic device according to claim 7, wherein execution of the instructions by the at least one processor causes the at least one processor to:
perform screen capturing processing on the current program being played to obtain the screen capturing picture;
send the microblog head, the microblog comment content and the screen capturing picture to the microblog server by using the microblog account number.

11. The electronic device according to claim 7, wherein execution of the instructions by the at least one processor causes the at least one processor to:
acquire the changed microblog account number if the microblog account number needs to be changed;
send the microblog head and the microblog comment content to the microblog server by using the changed microblog account number.

12. The electronic device according to claim 7, wherein execution of the instructions by the at least one processor causes the at least one processor to:
send the program name to the microblog server so as to send the microblog comments corresponding to the program name to the microblog client of the mobile terminal by the microblog server when the user needs to examine the microblog comments corresponding to the current program being played through the mobile terminal.

13. A non-transitory computer readable medium storing executable instructions that, when executed by an electronic device, cause the electronic device to:
acquiring a microblog sending starting command input by a user;
acquiring a program name corresponding to a current program being played if a microblog account number logs in;
processing the program name according to preset microblog head format to generate a microblog head;
acquiring the microblog comment content input by the user according to the microblog head;
and sending the microblog head and the microblog comment content to the microblog server by using the microblog account number.

14. The non-transitory computer readable medium according to claim 13, wherein the electronic device is further caused to:
acquire the microblog login information of the mobile terminal in the same local area network if no microblog accounting numbers log in;
log the microblog account number according to the microblog login information.

15. The non-transitory computer readable medium according to claim 14, wherein the electronic device is further caused to:
periodically detect the login state of the microblog account number in the mobile terminal in the local area network to acquire a detection result;
log off the microblog account number if the detection result indicates that the microblog account number is in an offline state in the mobile terminal within a preset time interval.

16. The non-transitory computer readable medium according to claim 13, wherein the electronic device is further caused to:
perform screen capturing processing on the current program being played to obtain the screen capturing picture;
send the microblog head, the microblog comment content and the screen capturing picture to the microblog server by using the microblog account number.

17. The non-transitory computer readable medium according to claim 13, wherein the electronic device is further caused to:
acquire the changed microblog account number if the microblog account number needs to be changed;
send the microblog head and the microblog comment content to the microblog server by using the changed microblog account number.

18. The non-transitory computer readable medium according to claim 13, wherein the electronic device is further caused to:
send the program name to the microblog server so as to send the microblog comments corresponding to the program name to the microblog client of the mobile terminal by the microblog server when the user needs to examine the microblog comments corresponding to the current program being played through the mobile terminal.
